(19) United States
(12) Patent Application Publication
(10) Pub. No.: US 2012/0038948 A1
(43) Pub. Date: Feb. 16, 2012

(54) METHOD AND SYSTEM FOR PRINTING TARGET FILES IN MOBILE TERMINAL

(75) Inventor: Woo Goo PARK, Daejeon (KR)

(73) Assignee: ELECTRONICS AND TELECOMMUNICATIONS RESEARCH INSTITUTE, Daejeon (KR)

(21) Appl. No.: 13/190,976

(22) Filed: Jul. 26, 2011

(30) Foreign Application Priority Data
Aug. 13, 2010 (KR) 10-2010-0078306

(51) Int. Cl. G06F 3/12

(52) U.S. Cl. 358/1.15

(57) ABSTRACT

A method and system for printing a file are provided. A mobile terminal may detect at least one accessible printer via a wireless communication, and a printer corresponding to a user's printing request may perform a printing desired by a user. Additionally, in response to the user's printing request, printing may be performed by a printer having a strongest wireless signal strength, a printer for supporting a printing type desired by the user, a printer having a smallest number of currently processed tasks, a printer having a highest printing speed, a printer having a model name or identification information related to a keyword of the user, a printer located closest to a mobile terminal, and a printer selected by the user.

### CROSS-REFERENCE TO RELATED APPLICATION

This application claims the benefit of Korean Patent Application No. 10-2010-0078306, filed on Aug. 13, 2010, in the Korean Intellectual Property Office, the disclosure of which is incorporated herein by reference.

### BACKGROUND

1. Field of the Invention

The present invention relates to a method and system for printing a file, and more particularly, to a method and system for automatically searching for an accessible printer via a wireless communication and requesting the discovered printer to print a target file.

2. Description of the Related Art

Generally, in a conventional printing method, when a user desires to obtain prints of a target file stored in a terminal, he or she selects a printer for printing the target file and requests printing of the target file, by mainly manipulating the terminal.

Here, the printing may be performed, only when drivers corresponding to printers for printing are installed in advance. Accordingly, in the conventional printing method, prior to printing, there is a need to download a driver corresponding to a model name of a printer via a compact disc (CD) or the Internet, and to install the downloaded driver, in response to a user's manipulation, thereby causing inconvenience to users.

Additionally, when information on a document type and a printing format of a target file that a user desires to print is stored in the terminal, an printer corresponding to the information needs to be installed in advance. Here, the printing format may include, for example, a paper size, availability or unavailability of color printing, and the like. To obtain prints with a desired printing format, a user needs to manually search for and select a printer supporting the desired printing format from among currently interoperable printers, thereby also causing inconvenience to users.

In particular, in a conventional printing method via a wireless communication, accessible printers may be detected and paired. However, it is difficult for a user to verify whether a desired printing format is supportable, or whether a printer is placed on a desired location.

### SUMMARY

An aspect of the present invention provides a method and system for printing a target file stored in a mobile terminal so that a printer satisfying a user's printing request may automatically perform printing desired by a user by detecting accessible neighboring printers via a wireless communication.

Another aspect of the present invention provides a method and system for printing a target file stored in a mobile terminal that may perform printing in response to a user's printing request by at least one of a printer having a strongest wireless signal strength, a printer for supporting a printing type desired by a user, a printer having a smallest number of currently performed tasks, a printer having a highest printing speed, a printer including a model name or identification information related to a keyword designated by the user, a printer located closest to the mobile terminal, and a printer selected by the user.

Another aspect of the present invention provides a method and system for printing a target file stored in a mobile terminal that may automatically install a driver for a printer accessible via a wireless communication without a user's manual manipulation.

Another aspect of the present invention provides a printing server that may interoperate with a plurality of printers, may provide an efficient printing service to an external mobile terminal, may charge costs for the printing service, and/or may provide a user with information regarding a location of a printer that performs the printing service.

According to an aspect of the present invention, there is provided a method of printing a target file stored in a mobile terminal, including: receiving a printing request from a user; searching for at least one accessible printer via a wireless communication, the at least one accessible printer being disposed proximate to the user; acquiring information regarding the discovered at least one printer; determining, among the discovered at least one printer, a printer including information corresponding to a selection mode in the printing request as a target printer, based on the acquired information; and requesting the determined target printer to print a target file corresponding to the printing request.

According to another aspect of the present invention, there is provided a method of providing a printing service in a printing server, including: receiving a printing request from a mobile terminal via a wireless network; determining, as a target printer, a printer including information corresponding to a selection mode in the printing request or corresponding to a selection mode, set in advance, among at least one printer, based on information regarding the at least one printer; and transferring the printing request to the determined target printer.

According to another aspect of the present invention, there is provided a mobile terminal, including: a printing initiation unit to receive a printing request from a user; a printer search unit to search for at least one accessible printer via a wireless communication, and to acquire information regarding the discovered at least one printer, the at least one accessible printer being disposed proximate to the user; a printer determination unit to determine, among the discovered at least one printer, a printer including information corresponding to a selection mode in the printing request as a target printer, based on the acquired information; and a printer request unit to request the target printer to print a target file corresponding to the printing request.

According to another aspect of the present invention, there is provided a printing server, including: a database to store information regarding at least one printer; and a controller to determine, as a target printer, a printer including information corresponding to a selection mode in a printing request among the at least one printer based on the information stored in the database, and to transfer the printing request to the determined target printer, when the printing request is received via a wireless network from a mobile terminal.

### Effect

According to embodiments of the present invention, a user may search for a wirelessly accessible printer that is disposed proximate to the user, to obtain desired prints from the printer.

Additionally, according to embodiments of the present invention, user's prints may be obtained by a most appropriate print among printers accessible via a wireless communication, thereby providing a user with a more rapid and convenient printing service. The most appropriate print may be, for example, a printer having a strongest wireless signal strength, a printer for supporting a printing type desired by a user, a printer having a smallest number of currently performed tasks, a printer having a highest printing speed, a printer including a model name or identification information related to a keyword designated by the user, a printer located closest to the mobile terminal, and the like.

Furthermore, according to embodiments of the present invention, it is possible to provide multiple users with a printing service through a server that provides a printing service by interoperating with a plurality of wired/wireless printers. In addition, the server may notify a user of location information of a printer that performs the printing service and thus, it is possible for the user to easily find prints of the user.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a system, to show a printing method according to an embodiment of the present invention;

FIG. 2 is a diagram illustrating operations of the system of FIG. 1;

FIG. 3 is a block diagram illustrating a configuration of a mobile terminal for performing a printing method according to another embodiment of the present invention;

FIGS. 4 and 5 are flowcharts illustrating operations of the mobile terminal of FIG. 3;

FIGS. 6 and 7 are diagrams illustrating examples of a screen of the mobile terminal of FIG. 3;

FIG. 8 is a diagram illustrating a system for performing a printing method according to another embodiment of the present invention;

FIG. 9 is a diagram illustrating the printing method performed in the system of FIG. 8; and

FIGS. 10A to 10C are diagrams illustrating examples of a screen of a mobile terminal in the system of FIG. 8.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

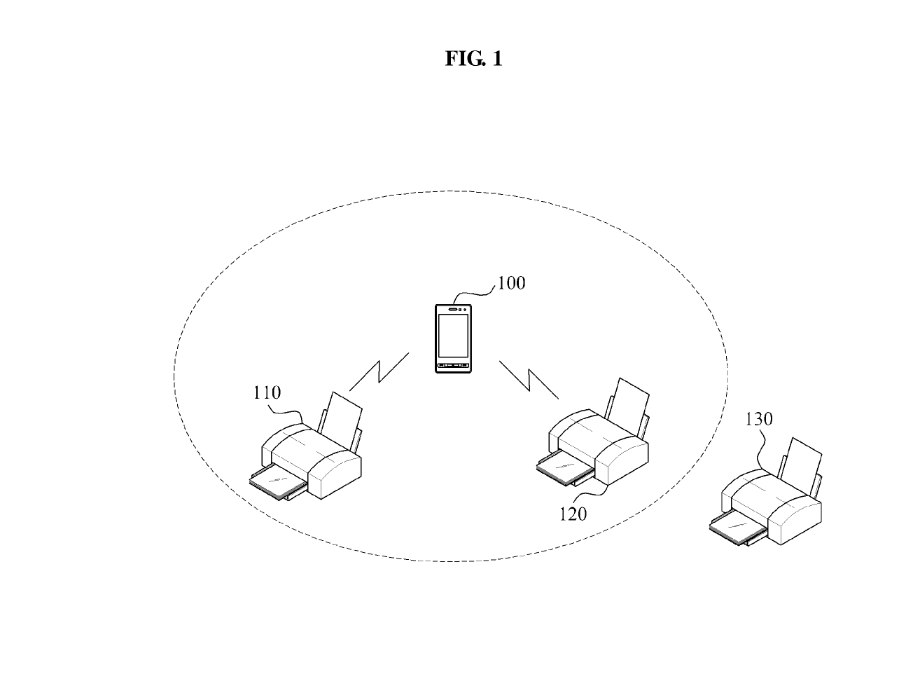

FIG. 1 is a diagram illustrating a system, to show a printing method according to an embodiment of the present invention.

Referring to FIG. 1, the system may include a mobile terminal 100, and a plurality of printers 110, 120 and 130.

The mobile terminal 100 may include a wireless communication module to enable the mobile terminal 100 to interoperate with accessible printers A 110 and B 120 among the plurality of printers 110, 120 and 130. Here, the accessible printers A 110 and B 120 may be disposed proximate to a user. When a printing request is received from a user, the mobile terminal 100 may determine, as a target printer, one of the printers A 110 and B 120 that may interoperate with the mobile terminal 100, based on a selection mode set by the user in the printing request, and may transfer the received printing request to the target printer.

The selection mode may exist as setting information in the printing request, however, there is not limitation thereto. Accordingly, the selection mode may exist as information generated through a separate setting operation by the user.

Each of the plurality of printers 110, 120 and 130 may include a wireless communication module to enable interoperation with the mobile terminal 100. The plurality of printers 110, 120 and 130 may respond to an access request received via their respective wireless communication modules, and may perform printing in response to the received printing request.

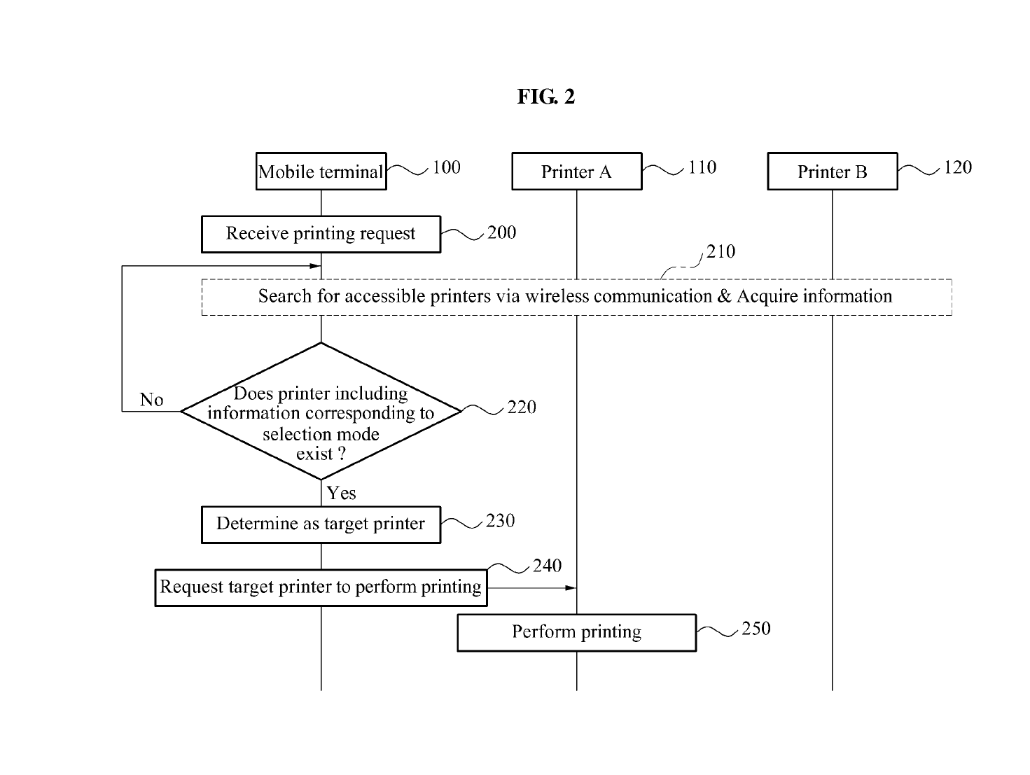

FIG. 2 is a diagram illustrating operations of the system of FIG. 1.

Referring to FIG. 2, in operation 200, the mobile terminal 100 may receive the printing request based on a user's manipulation.

In operation 210, the mobile terminal 100 may search for the accessible printers A 110 and B 120 via a wireless communication, and may acquire information regarding the discovered printers A 110 and B 120.

In operation 220, the mobile terminal 100 may determine whether a printer including information corresponding to the selection mode exists among the discovered printer A 110 and discovered printer B 120. Here, selection mode may be set by the user in the printing request.

In operation 230, the mobile terminal 100 may determine the printer A 110 as a target printer, when the printer A 110 is determined to include the information corresponding to the selection mode. Hereinafter, the printer A 110 may be referred to as the target printer A 110.

In operation 240, the mobile terminal 100 may request the target printer A 110 to perform printing.

In operation 250, the target printer A 110 may perform the requested printing.

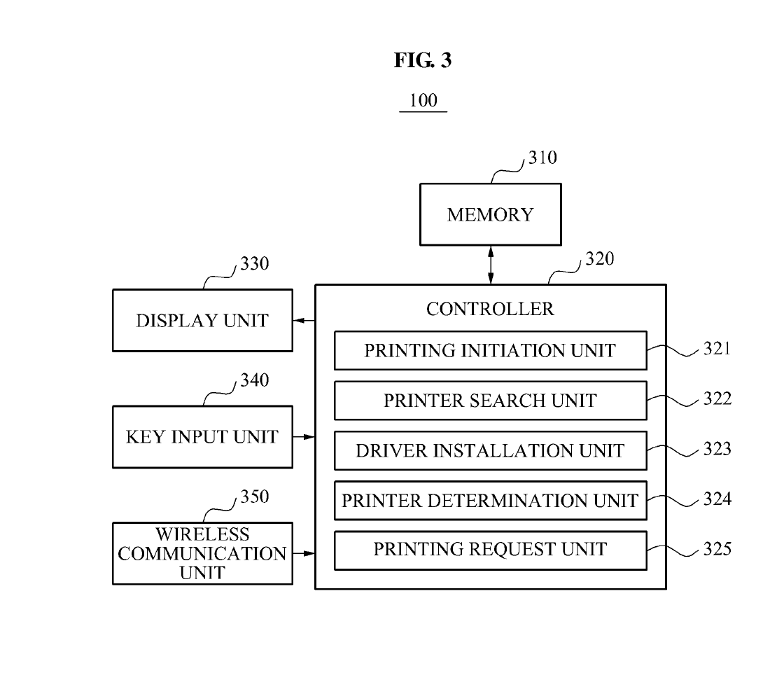

FIG. 3 is a diagram illustrating a configuration of the mobile terminal 100 for performing a printing method according to another embodiment of the present invention.

Referring to FIG. 3, the mobile terminal 100 may include a memory 310, a controller 320, a display unit 330, a key input unit 340, and a wireless communication unit 350.

The memory 310 may be implemented as a storage medium, for example a read only memory (ROM), a flash memory, a random access memory (RAM), and the like. Additionally, the memory 310 may store a program used to perform printing and an operation of the controller 320, and a variety of reference data. Hereinafter, the program will be referred to as a ‘printing application’.

In particular, the memory 310 may store a plurality of target files that are requested to be printed in response to a user's printing request. Here, the target files may include, for example, documents, pictures, e-mails, and the like.

Additionally, the memory 310 may store drivers for the at least one printer, or store an installation file used to install the drivers, in order to interoperate with the at least one printer.

The controller 320 may control the memory 310, the display unit 330, the key input unit 340, and the wireless communication unit 350 in the mobile terminal 100, and may execute the printing application stored in the memory 310. When the printing request is received from the user, the controller 320 may execute the printing application, may search for currently accessible printers, and may transfer the printing request to a target printer that is selected from among the discovered printers.

The controller 320 may include a printing initiation unit 321, a printer search unit 322, a driver installation unit 323, a printer determination unit 324, and a printing request unit 325.

The printing initiation unit 321 may initiate the printing application stored in the memory 310, in response to the printing request from the user. Here, the printing request may include, for example, settings for at least one of a target file to be printed, a printing format of the target file, a selection mode, and a keyword.

The printing initiation unit 321 may initiate the printing application in response to the printing request, however, there is no limitation thereto. Accordingly, after a request to execute the printing application is received from the user, the printing initiation unit 321 may initiate the printing application, and may receive a printing request input by the user through a separate input screen (not shown).

The printer search unit 322 may search for at least one accessible printer via the wireless communication unit 350, and may acquire information regarding the discovered at least one printer. Here, the at least one accessible printer may be disposed proximate to a user. Additionally, the printer search unit 322 may interoperate with the wireless communication unit 350, may access a neighboring access point (AP, not shown), and may search for the at least one accessible printer through the AP.

Here, the acquired information may include at least one of information regarding a wireless signal strength, a set printing type, information regarding a number of tasks, printing speed information, a model name, identification information, and location information with respect to each of the discovered at least one printer. The above information may be received from each of the at least one printer or from the AP, or may be acquired from a driver installed for each of the at least one printer.

The driver installation unit 323 may search for a printer without a driver from among the at least one printer discovered by the printer search unit 322, and may install a driver corresponding to the discovered printer. Additionally, when the driver corresponding to the discovered printer is installed, the at least one printer disposed adjacent to the mobile terminal 100 may interoperate with the mobile terminal 100.

The printer determination unit 324 may determine, as a target printer, a printer including information corresponding to the selection mode in the printing request, from among the at least one printer discovered by the printer search unit 322.

Here, the selection mode may be set in advance by the user, or may be selected in real-time in response to the printing request. The selection mode may include at least one of a wireless signal priority mode, a printing type priority mode, a speed priority mode, a task number priority mode, a keyword priority mode, and a user selection mode.

In an example, when the wireless signal priority mode is set as the selection mode, the printer determination unit 324 may select a printer having a strongest wireless signal strength from among the at least one printer discovered by the printer search unit 322, based on information regarding a wireless signal strength of each of the discovered at least one printer, and may determine the selected printer as a target printer. In this example, the printer A 110 may be determined as the target printer.

In another example, when the printing type priority mode is set as the selection mode, the printer determination unit 324 may select a printer for supporting a printing type set in the printing request from among the at least one printer discovered by the printer search unit 322, based on printing type information of each of the discovered at least one printer, and may determine the selected printer as a target printer. In this example, the printer A 110 may be determined as the target printer.

In still another example, when the task number priority mode is set as the selection mode, the printer determination unit 324 may select a printer having a smallest number of tasks from among the at least one printer discovered by the printer search unit 322, based on information regarding a number of tasks of each of the discovered at least one printer, and may determine the selected printer as a target printer. In this example, the printer A 110 may be determined as the target printer.

In a further another example, when the speed priority mode is set as the selection mode, the printer determination unit 324 may select a printer having a highest printing speed from among the at least one printer discovered by the printer search unit 322, based on printing speed information of each of the discovered at least one printer, and may determine the selected printer as a target printer. In this example, the printer A 110 may be determined as the target printer.

In a further another example, when the keyword priority mode is set as the selection mode, the printer determination unit 324 may select a printer having a model name or identification information related to a keyword in the printing request from among the at least one printer discovered by the printer search unit 322, based on a model name or identification information of each of the discovered at least one printer, and may determine the selected printer as a target printer. In this example, the printer A 110 may be determined as the target printer.

In a further another example, when the user selection mode is set as the selection mode, the printer determination unit 324 may display, on a screen, information regarding the discovered at least one printer, and may determine, as a target printer, a printer selected through the screen from among the discovered at least one printer. In this example, the printer A 110 may be determined as the target printer.

The printing request unit 325 may request the target printer determined by the printer determination unit 324 to print a target file corresponding to the printing request. Specifically, the printing request unit 325 may convert the target file into data of a format for printing, and may transfer the converted data to the target printer.

The display unit 330 may provide a screen for display of data, and may display screens in response to a request by the printing application.

The key input unit 340 may receive information, based on generated key data and a plurality of pieces of input data. In particular, the key input unit 340 may receive input information required by the printing application. The input information may include, for example, a printing request, printing settings, a mode change, a printer selection, and other information required for the printing request.

The wireless communication unit 350 may detect an neighboring apparatus including a wireless communication module. Accordingly, the wireless communication unit 350 may be implemented, for example, as a Wireless Broadband (WiBro), an Infrared Data Association (IrDA) based communication module, a Bluetooth module, a ZigBee module, and the like.

The wireless communication unit 350 may search for a neighboring printer that initiates a wireless communication, and may access the discovered printer under a control of the controller 320. Additionally, the wireless communication unit 350 may also access an AP for printing a separate wireless network, or a printing server for providing a separate printing service.

As described above, the driver installation unit 323 may determine whether a driver is installed for all printers discovered by the printer search unit 322, and may install a corresponding driver, however, there is no limitation thereto. Accordingly, the driver installation unit 323 may selectively determine whether a driver is installed for the target printer determined by the printer determination unit 324 or for a printer selected by the user (for example, the printer B 120), and may install a corresponding driver.

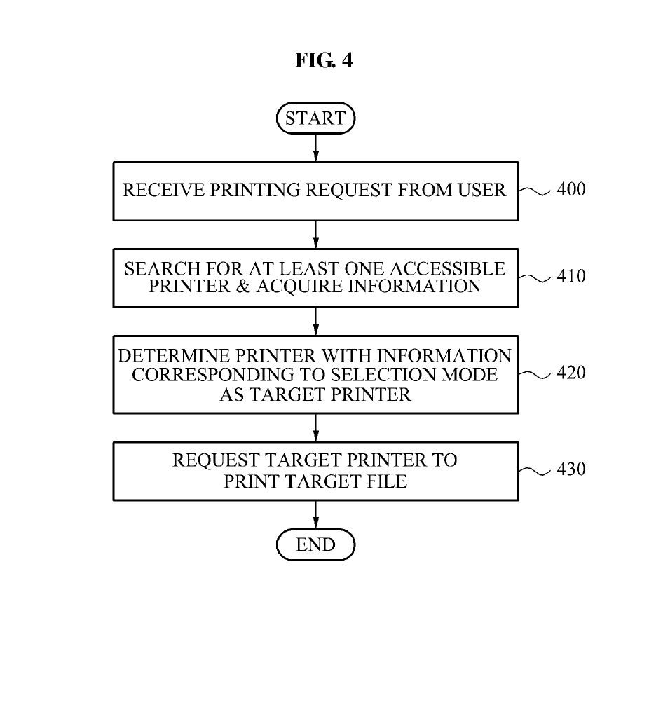

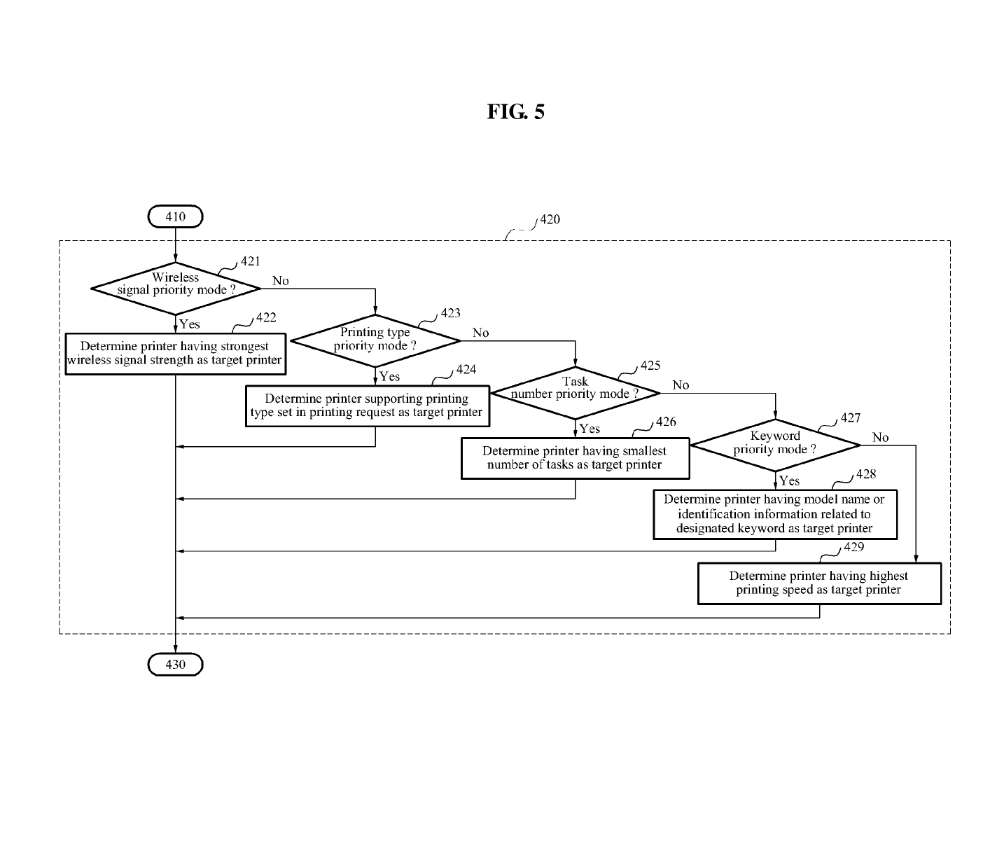

FIGS. 4 and 5 are flowcharts illustrating operations of the mobile terminal 100 of FIG. 3.

Referring to FIG. 4, in operation 400, the mobile terminal 100 may receive the printing request from the user based on the key data generated by the key input unit 340. Additionally, in operation 400, the mobile terminal 100 may initiate the printing application in response to the printing request.

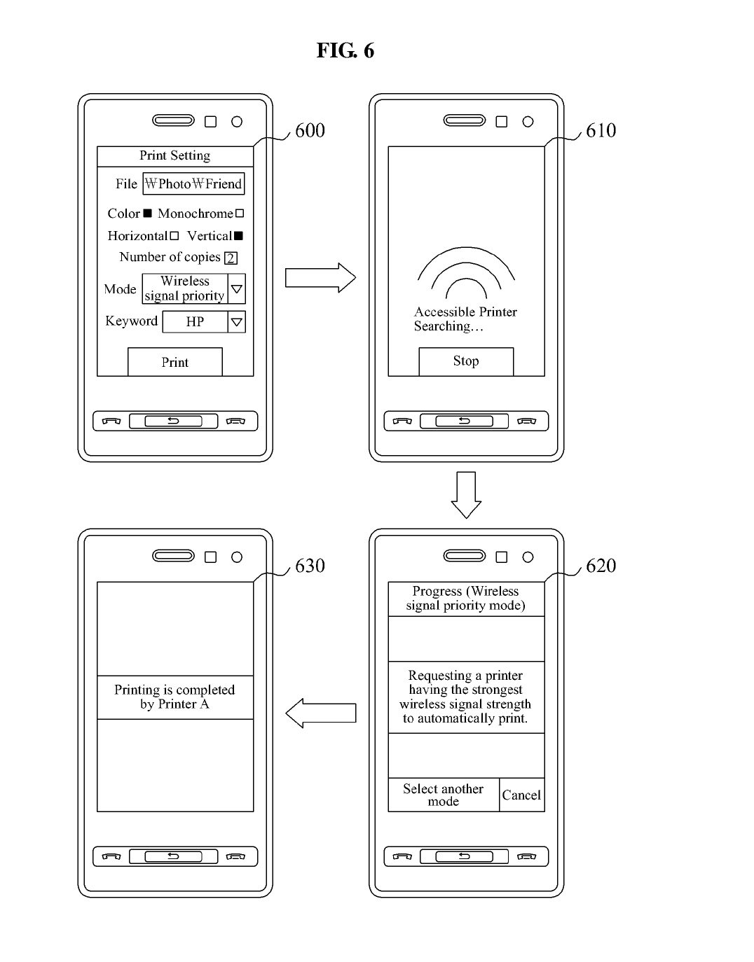

In operation 400, the mobile terminal 100 may display a screen 600 as shown in FIG. 6, and may generate the printing request using data input through the screen 600.

Referring to FIG. 6, the screen 600 may receive input of a setting of a path for a target file, a setting of whether to print in color or monochrome, a setting of whether to use a horizontal page or a vertical page, a setting of a number of sheets, a setting of a printing mode, and a setting of a keyword.

In operation 410, the mobile terminal 100 may search for the at least one accessible printer via the wireless communication unit 350. In operation 410, the mobile terminal 100 may display a screen 610 as shown in FIG. 6, to notify the user of a progress of the searching.

Additionally, in operation 410, the mobile terminal 100 may acquire information regarding each of the discovered at least one printer. Here, the acquired information may include at least one of information regarding a wireless signal strength, a set printing type, information regarding a number of tasks, printing speed information, a model name, identification information, and location information with respect to each of the discovered at least one printer.

To acquire the information in operation 410, access information may be acquired from each of the discovered at least one printer, or a driver for the discovered at least one printer may be installed.

In operation 420, the mobile terminal 100 may determine, as a target printer, a printer including information corresponding to the selection mode in the printing request, from among the at least one printer discovered in operation 410.

Here, the selection mode may include at least one of the wireless signal priority mode, the printing type priority mode, the speed priority mode, the task number priority mode, and the keyword priority mode.

Operation 420 may include a plurality of operations shown in FIG. 5.

Referring to FIG. 5, in operation 421, the mobile terminal 100 may determine whether the wireless signal priority mode is set. When operation 421 determines that the wireless signal priority mode is set, the mobile terminal 100 may determine, as a target printer, a printer having a strongest wireless signal strength among the discovered at least one printer in operation 420.

When operation 421 determines that the wireless signal priority mode is not set, the mobile terminal 100 may determine whether the printing type priority mode is set in operation 423. When operation 423 determines that the printing type priority mode is set, the mobile terminal 100 may determine, as a target printer, a printer for supporting a printing type set in the printing request among the discovered at least one printer in operation 424.

When operation 423 determines that the printing type priority mode is not set, the mobile terminal 100 may determine whether the task number priority mode is set in operation 425. When operation 425 determines that the task number priority mode is set, the mobile terminal 100 may determine, as a target printer, a printer having a smallest number of tasks among the discovered at least one printer in operation 426.

When operation 425 determines that the task number priority mode is not set, the mobile terminal 100 may determine whether the keyword priority mode is set in operation 427. When operation 427 determines that the keyword priority mode is set, the mobile terminal 100 may determine, as a target printer, a printer having a model name or identification information related to a keyword designated by the user among the discovered at least one printer in operation 428.

When operation 427 determines that the keyword priority mode is not set, the mobile terminal 100 may determine, as a target printer, a printer having a highest printing speed among the discovered at least one printer in operation 429.

In operation 430, the mobile terminal 100 may request the target printer determined in operation 420 to print the target file.

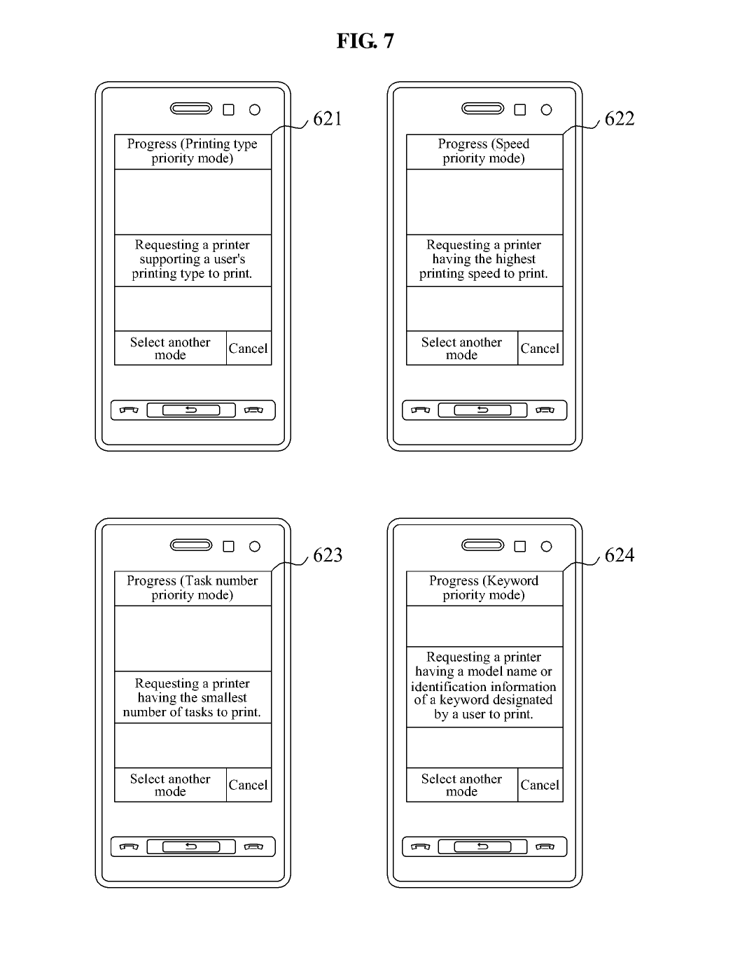

In operation 430, for example, the mobile terminal 100 may provide a screen 620 showing a progress of the wireless signal priority mode, as shown in FIG. 6, so that the user may view a process of requesting the target printer to print the target file, or may select another mode through the screen 620. In this example, when the user selects another mode through the screen 620, the mobile terminal 100 may provide one of screens 621 through 624 as shown in FIG. 7, so that the user may view a progress of the selected mode. In FIG. 7, the screens 621 through 624 may respectively show progresses of a printing type priority mode, a speed priority mode, a task number priority mode, and a keyword priority mode.

Additionally, in operation 430, when printing of the target file is completed, the mobile terminal 100 may provide a screen 630 as shown in FIG. 6, to notify the user of completion of the printing.

Therefore, the printer determined as the target printer by the mobile terminal 100 from among the at least one printer disposed proximate to the mobile terminal 100 may print the target file.

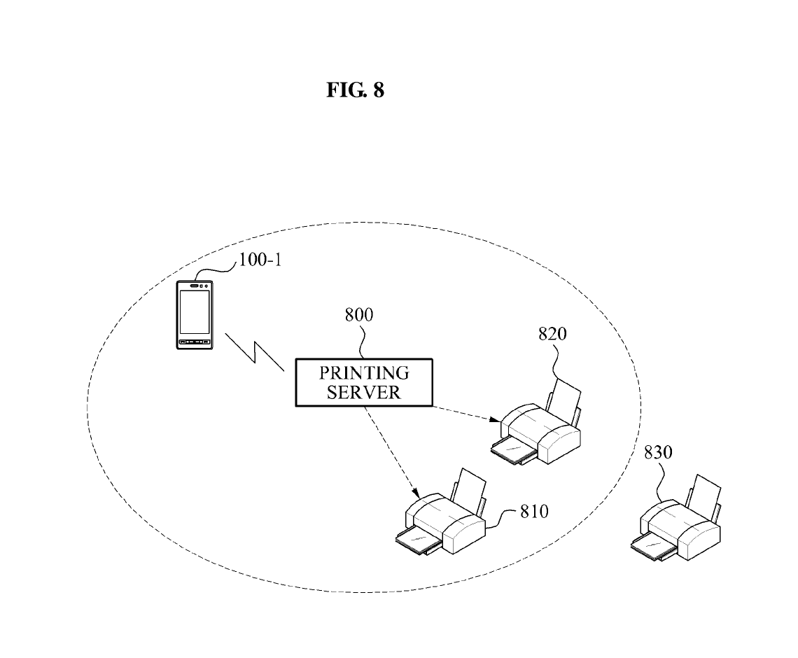

FIG. 8 is a diagram illustrating a system for performing a printing method according to another embodiment of the present invention.

Referring to FIG. 8, the system may be configured with a separate printing server 800 to perform the printing method. The system may include a mobile terminal 100-1, the printing server 800, and a plurality of printers 810, 820 and 830.

The mobile terminal 100-1 may access the printing server 800 via a mobile communication network or a wireless network depending on a user's manipulation. Additionally, the mobile terminal 100-1 may transmit, to the printing server 800, a printing request received from the user.

When the printing request is received from the mobile terminal 100-1, the printing server 800 may transfer the printing request to a target printer including information corresponding to a selection mode in the printing request between the printers A 810 and B 820 that are currently accessible by the printing server 800 and are able to perform printing. For example, the printer A 810 may be determined as the target printer.

Accordingly, the printing server 800 may include a database (not shown), and may store, in the database in advance, information regarding the printers A 810 and B 820.

Here, the stored information may include at least one of information regarding a wireless signal strength, a set printing type, information regarding a number of tasks, printing speed information, a model name, identification information, and location information with respect to each of the printers A 810 and B 820.

Additionally, the printing server 800 may provide the mobile terminal 100-1 with the information stored in the database, may receive a selection of the target printer directly from the mobile terminal 100-1.

After transferring the printing request to the target printer, the printing server 800 may transmit location information corresponding to the target printer to the mobile terminal 100-1, or may charge costs for the printing request to the mobile terminal 100-1.

The plurality of printers 810, 820 and 830 may interoperate with the printing server 800 via a wired or wireless communication. To interoperate with the printing server 800 via the wireless communication, the plurality of printers 810, 820 and 830 need to include wireless communication modules. However, to interoperate with the printing server 800 via the wired communication, the plurality of printers 810, 820 and 830 do not need to include a wireless communication module, similarly to a general printer.

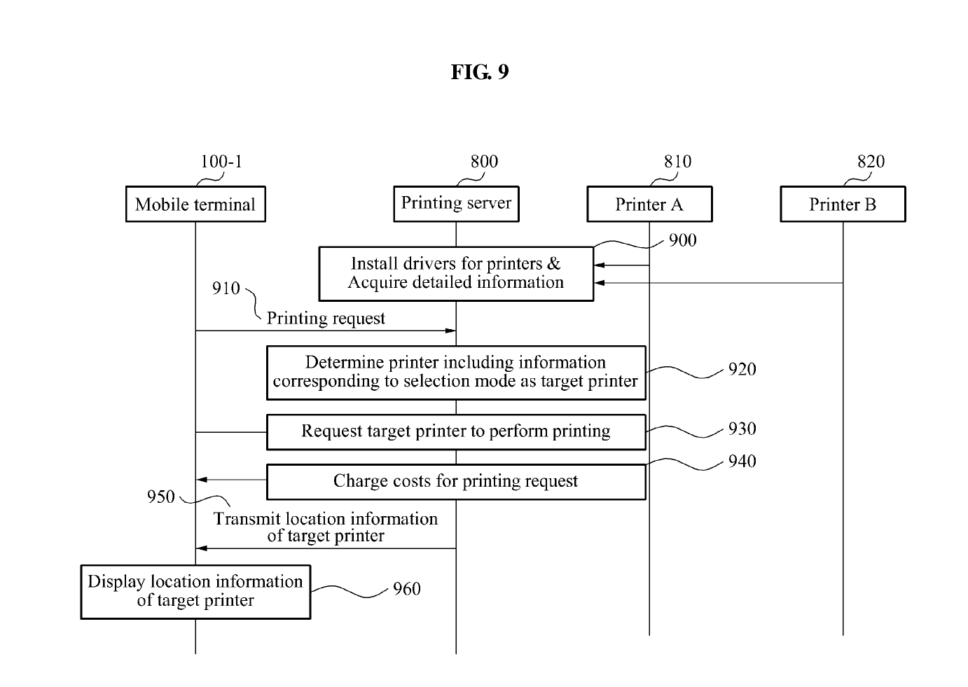

FIG. 9 is a diagram illustrating the printing method performed in the system of FIG. 8.

Referring to FIG. 9, in operation 900, the printing server 800 may install a driver for each of the printers A 810 and B 820 and may acquire detailed information regarding the printers A 810 and B 820, through an interoperation with the printers A 810 and B 820.

In operation 910, the printing server 800 may receive a user's printing request from the mobile terminal 100-1.

The printing request may include a target file to be printed, and settings for at least one of a printing format of the target file, a selection mode, and a keyword.

In operation 920, in response to the printing request, the printing server 800 may determine, as a target printer, the printer A 810 including information corresponding to a selection mode in the printing request, from between the printers A 810 and B 820. Hereinafter, the printer A 810 may be referred to as the target printer A 810.

Here, the selection mode may exist as information included in the printing request, or may be designated in accordance with an internal policy of the printing server 800. Additionally, the selection mode may include at least one of a wireless signal priority mode, a printing type priority mode, a speed priority mode, a task number priority mode, a keyword priority mode, and a user selection mode.

In an example, when one of the wireless signal priority mode, the printing type priority mode, the speed priority mode, the task number priority mode, and the keyword priority mode is selected, operation 920 may be performed similarly to an operation corresponding to the selected mode among operations 422, 424, 426, 428, and 429 of FIG. 5.

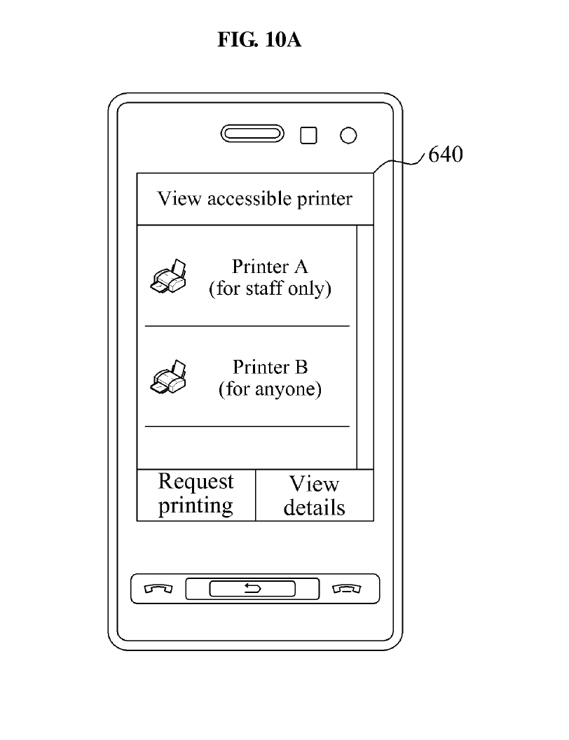

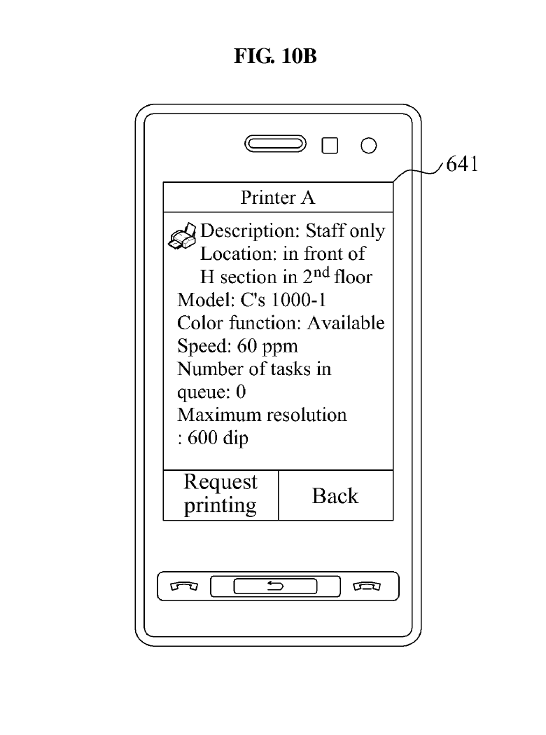

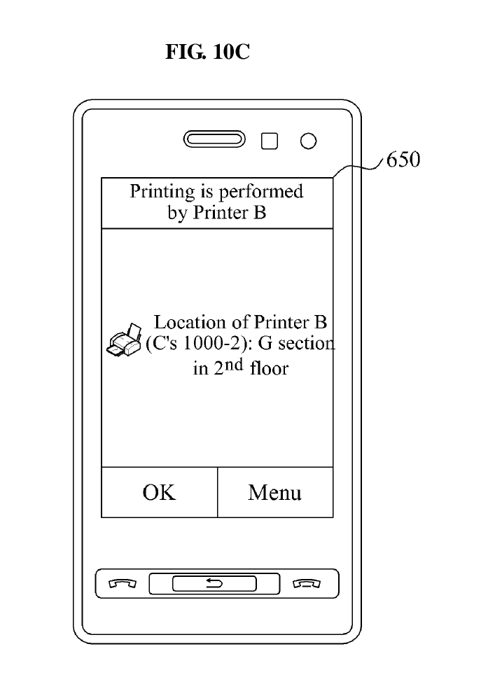

In another example, when the user selection mode is set as the selection mode, the printing server 800 may transmit, to the mobile terminal 100-1, a list of the currently accessible printers A 810 and B 820, and the detailed information regarding the printers A 810 and B 820 in operation 920. In this example, the mobile terminal 100-1 may provide a screen 640 of FIG. 10A, to display the list of the accessible printers A 810 and B 820. Additionally, the mobile terminal 100-1 may provide a screen 641 of FIG. 10B, to show a user the detailed information regarding the printer A 810. In addition, the mobile terminal 100-1 may transmit, to the printing server 800, a message indicating the printer B 820 selected by the user through a screen 640 and 641 of FIG. 10C.

Accordingly, in response to the message from the mobile terminal 100-1, the printing server 800 may determine, as the target printer, the printer B 820 selected by the user in operation 920.

In operation 930, the printing server 800 may transfer the printing request to the target printer determined in operation 920.

In operation 940, the printing server 800 may charge costs for the printing request to the mobile terminal 100-1.

Specifically, in operation 940, the printing server 800 may analyze the printing request, and may charge the costs based on settings for whether to print in color or monochrome, for whether to use a horizontal page or a vertical page, and for a number of sheets. Here, the settings may be included in the printing request.

In operation 950, the printing server 800 may transmit location information of the target printer to the mobile terminal 100-1.

In operation 960, the mobile terminal 100-1 may receive the location information from the printing server 800, and may display the received location information on a screen.

For example, in operation 960, the mobile terminal 100-1 may provide the screen 650 of FIG. 10C, to display the location information of the target printer B 820.

In this example, the user may easily check, through the screen 650, a location of the target printer B 820 where printing is performed, and may go to the location to find prints. The target printer A 810 may be located in a “G section in the 2^{nd} floor,” as shown in FIG. 10C.

As a result, the printing server 800 may automatically or semiautomatically transfer, to the target printer, the user's printing request input via the mobile terminal 100-1. Accordingly, a user of the mobile terminal 100-1 may obtain desired prints without a need to separately install a printer for interoperating with the printing server 800, even when there is no printer directly interoperating with the mobile terminal 100-1.

Additionally, the user may easily search for a printer supporting a desired printing format or a printer in a desired location, via a wireless communication, and may request the discovered printer to print a target file.

The methods according to the above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of printing a target file stored in a mobile terminal, the method comprising:
receiving a printing request from a user;
searching for at least one accessible printer via a wireless communication, the at least one accessible printer being disposed proximate to the user;
acquiring information regarding the discovered at least one printer; and
determining, among the discovered at least one printer, a printer including information corresponding to a selection mode in the printing request as a target printer, based on the acquired information.

2. The method of claim 1, wherein the determining comprises determining, as the target printer, a printer having a strongest wireless signal strength among the discovered at least one printer, when a wireless signal priority mode is set as the selection mode.

3. The method of claim 1, wherein the determining comprises determining, as the target printer, a printer for supporting a printing type set in the printing request among the discovered at least one printer, when a printing type priority mode is set as the selection mode.

4. The method of claim 1, wherein the determining comprises determining, as the target printer, a printer having a smallest number of tasks among the discovered at least one printer, when a task number priority mode is set as the selection mode.

5. The method of claim 1, wherein the determining comprises determining, as the target printer, a printer having a highest printing speed among the discovered at least one printer, when a speed priority mode is set as the selection mode.

6. The method of claim 1, wherein the determining comprises determining, as the target printer, a printer having a model name or identification information related to a keyword designated by the user in the printing request among the discovered at least one printer, when a keyword priority mode is set as the selection mode.

7. The method of claim 1, wherein the determining comprises determining, as the target printer, a printer located closest to the mobile terminal among the discovered at least one printer, when a location priority mode is set as the selection mode.

8. The method of claim 1, wherein the determining comprises displaying on a screen the information regarding the discovered at least one printer, and determining, as the target printer, a printer selected through the screen among the discovered at least one printer, when a user selection mode is set as the selection mode.

9. The method of claim 1, further comprising:
searching for a printer without a driver from among the discovered at least one printer and installing the driver corresponding to the discovered printer, when the at least one printer is discovered via the wireless communication.

10. The method of claim 1, further comprising:
determining whether a driver of the target printer is installed when the target printer is determined, and installing the driver of the target printer when determining that the driver of the target printer is not installed.

11. The method of claim 1, wherein the searching comprises accessing an access point (AP) for providing a wireless network, and searching for the at least one accessible printer through the AP.

12. The method of claim 1, further comprising:
requesting the determined target printer to print a target file corresponding to the printing request.

13. A method of providing a printing service in a printing server, the method comprising:
receiving a printing request from a mobile terminal via a wireless network;
determining, as a target printer, a printer including information corresponding to a selection mode in the printing request or corresponding to a selection mode, set in advance, among at least one printer, based on information regarding the at least one printer; and
transferring the printing request to the determined target printer.

14. The method of claim 13, further comprising:
transmitting information regarding a location of the target printer to the mobile terminal, when the printing request is transferred to the target printer.

15. The method of claim 13, further comprising:
charging, to the mobile terminal, costs for the printing request.

16. A mobile terminal, comprising:
a printing initiation unit to receive a printing request from a user;
a printer search unit to search for at least one accessible printer via a wireless communication, and to acquire information regarding the discovered at least one printer, the at least one accessible printer being disposed proximate to the user;
a printer determination unit to determine, among the discovered at least one printer, a printer including information corresponding to a selection mode in the printing request as a target printer, based on the acquired information; and
a printer request unit to request the target printer to print a target file corresponding to the printing request.

17. The mobile terminal of claim 16, wherein the selection mode comprises at least one of a wireless signal priority mode, a printing type priority mode, a speed priority mode, a task number priority mode, a keyword priority mode, a location priority mode, and a user selection mode.

18. The mobile terminal of claim 16, further comprising:
a driver installation unit to search for a printer without a driver from among the at least one printer discovered by the printer search unit and the target printer determined by the printer determination unit, and to install the driver corresponding to the discovered printer.

19. The mobile terminal of claim 16, wherein the printer search unit accesses an access point for providing a wireless network, and searches for the at least one accessible printer through the access point.

20. A printing server, comprising:
a database to store information regarding at least one printer; and
a controller to determine, as a target printer, a printer including information corresponding to a selection mode in a printing request among the at least one printer based on the information stored in the database, and to transfer the printing request to the determined target printer, when the printing request is received via a wireless network from a mobile terminal.
